(19) United States
(12) Patent Application Publication
(10) Pub. No.: US 2006/0235901 A1
(43) Pub. Date: Oct. 19, 2006

(54) Systems and methods for dynamic burst length transfers

(76) Inventor: Wing M. Chan, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/109,167

(22) Filed: Apr. 18, 2005

(51) Int. Cl. G06F 17/30

(52) U.S. Cl. 707/201

(57) ABSTRACT

A method for performing dynamic burst transfers between a first computer system and a second computer system includes monitoring time delay associated with communicating messages between the first computer system and the second computer system. Contention for resources in at least one of the first computer system and the second computer system can also be monitored. A transfer mode indicating whether data should be transferred in one message or multiple messages between the first and second computer systems is determined based on the time delay and/or the level of contention for resources.

### BACKGROUND

Performance improvements in computing and storage, along with motivation to exploit these improvements in highly challenging applications, have increased the demand for extremely fast data links, for example in areas of high-speed and data-intensive networking. One example of a highly challenging application is data replication in information storage and retrieval, where, for systems that are expected to operate continuously, a duplicate and fully operational backup capability is typically implemented in the event a primary system fails. The copies may reside on the same or different devices or systems. Similarly, the duplicates may reside on local or remote devices or systems. The obvious advantage of remote replication is avoiding destruction of both the primary and secondary copies in the event of a disaster occurring in one location.

Corporations, institutions, and agencies sharing common databases and storage systems often include enterprise units that are widely dispersed geographically and therefore may use data replication over very large distances. Additionally, new time-sensitive applications such as remote web mirroring for real-time transactions, data replication, and streaming services are increasing the demand for high-performance SAN extension solutions. Distance between storage sites increases communication latency, and reduces speed and reliability, although the demand for fast communication remains.

In response to the demand for fast data communication links, various network interconnect standards have been developed to enable faster communication between computers and input/output devices. One example of an interconnect standard is a Fibre Channel (FC) standard and associated variants, which are defined in an effort to facilitate data communication, including network and channel communication, between and among multiple processors and peripheral devices. The Fiber Channel standard enables transfers of large information amounts at very high rates of two or more gigabits (Gb) per second.

Remote replication links in storage systems tend to be exclusively standard links with a specified standard throughput, for example 1-2 Gb for the Fiber Channel standard. An alternative to FC is iSCSI. iSCSI (internet small computer systems interface), a new Internet Protocol (IP)-based storage protocol that will be used in Ethernet-based SANs, is essentially SCSI over transmission control protocol (TCP) over Internet protocol (IP). Replication links may be implemented on other standards, such as Enterprise Systems Connection (ESCON), Small Computer Systems Interface (SCSI), and others.

Regardless of the technology (FC, iSCSI, or other protocol), performance is affected by many factors such as the distance between the data centers, the amount of data traffic and the bandwidth of various components in a network, the transport protocols (e.g., synchronous optical network (SONET), asynchronous transfer mode (ATM), and IP) and the reliability of the transport medium. Recent advances in optical communication technology has addressed the issue with data rate and bandwidth. Time delay of signaling over long distances becomes a primary factor in performance.

### BRIEF DESCRIPTION OF THE FIGURES

Embodiments disclosed herein may be better understood by referencing the accompanying drawings. The use of the same reference symbols in different drawings indicates similar or identical items.

FIG. 1 is a schematic block diagram of an embodiment of a network configured to perform dynamic burst length data transfers;

FIG. 2 is a schematic block diagram of an embodiment of a Fiber Channel-SCSI network configured to perform dynamic burst length data transfers;

FIG. 3 is a flow diagram of an embodiment of a method for performing dynamic burst length data transfer in a host computer; and

FIG. 4 is a flow diagram of an embodiment of a method of performing dynamic burst length data transfer in a target system.

### DETAILED DESCRIPTION

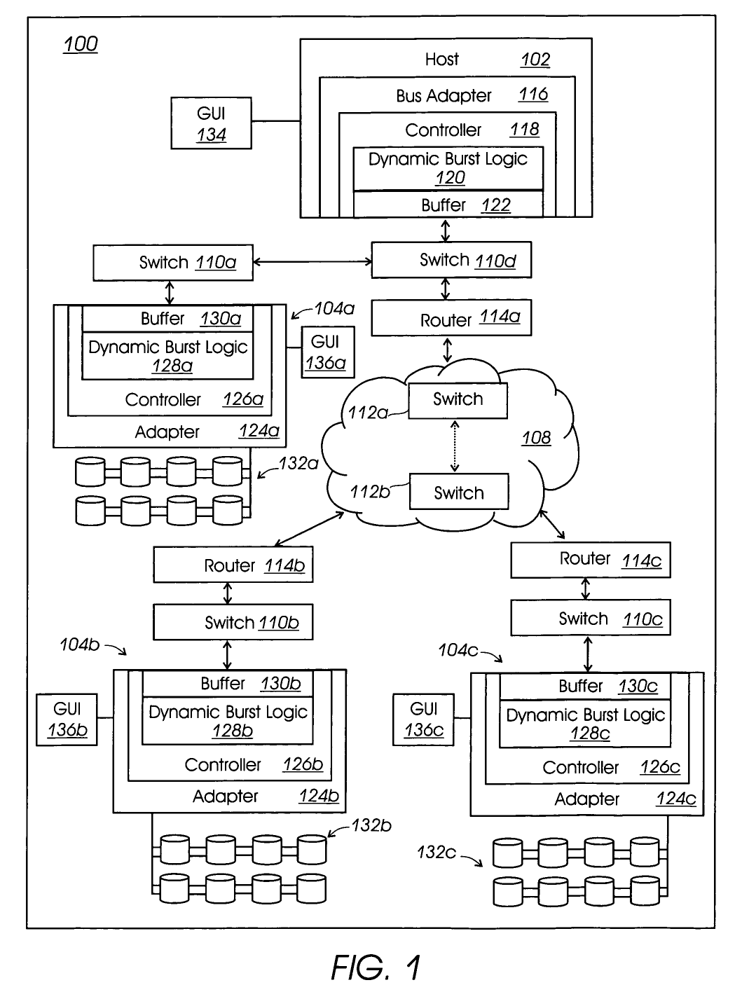

Embodiments and techniques disclosed herein can be used to optimize data transfer between local and remote resources. The originator and target systems can be located in the same facility, or tens or even hundreds of miles away from each other. Minimizing the time delay associated with data transfers improves response time and reliability. FIG. 1 depicts an embodiment of wide-area distributed storage area network (DSAN) 100 that can include one or more host computers 102 configured to transfer data to and from local and remote target computer systems, such as disk storage systems 104b, 104c, 104d, for example. Components in local networks and wide area networks (WANs) 108 in DSAN 100, such as switches 110, 112 and routers 114, can comply with one or more suitable communication protocols to allow host computers 102 and storage systems 104 to communicate over a wide range of distances, for example, from less than 1 meter to 100 kilometers (km) or more.

Note that, to simplify notation, similar components and systems designated with reference numbers suffixed by the letters “a”, “b”, “c”, or “d” are referred to collectively herein by the reference number alone. Although such components and systems may perform similar functions, they can differ in some respects from other components with the same reference number. For example, storage systems 104b, 104c, 104d may be collectively referred to as storage systems 104, however, storage systems 104 may not include the same number or type of components.

Host computer 102 can include one or more bus adapters 116 that interface with switch 110d. Bus adapter 116 can include one or more controllers 118 with dynamic burst logic 120 and buffer(s) 122 that operate to selectively increase or decrease the number or size of messages that are used to transfer a given amount of data. Similarly, storage systems 104 can include adapters 124 that interface with corresponding switches 110a, 110b, 110c and include one or more controllers 126 with dynamic burst logic 128 and buffer(s) 130. Adapters 124 are coupled to access one or more storage elements 132, such as SCSI, Redundant Array of Independent Disks (RAID), or Integrated Drive Electronics (IDE) disk drives or other suitable storage devices.

In the embodiment shown, components in DSAN 100 can comply with one or more suitable communication technologies such as, for example, direct connection using optical fiber or other suitable communication link, dense wave division multiplexers (DWDM), Internet protocol (IP), small computer systems interface (SCSI), internet SCSI (iSCSI), fiber channel (FC), fiber channel over Internet protocol (FC-IP), synchronous optical network (SONET), asynchronous transfer mode (ATM), Enterprise System Connection (ESCON), and/or proprietary protocols such as IBM's FICON® protocol. Suitable technology such as FC fabrics (i.e., a group of two or more FC switches) and arbitrated loops may be used to allow access among multiple hosts and target systems. Data is transferred between systems using messages that are formatted according to the protocol(s) being used by components in host 102 and storage systems 104.

Some technologies, such as FC, may be limited to practical distances of about 100 km, however data can be carried over longer distances via wide-area networks 108 using devices that comply with other communication technologies that are suited for longer distances. For example, components in WAN 108, such as switches 112 and routers (not shown), can comply with the Internet protocol (IP), synchronous optical network (SONET) protocol, and/or gigabit Ethernet (GE) protocol. Note that, in general, WAN 108 can manage multiple streams and channels of data in multiple directions over multiple ports over multiple interfaces. To simplify the description, this multiplicity of channels, ports, and interfaces is not discussed herein. However, embodiments disclosed herein may be extended to include multiple channels, ports, and interfaces.

In the embodiment shown in FIG. 1, a transmission from host 102 to one or more storage elements 132b, can be transmitted using FC protocol to switch 110d, router 114a, and WAN 108. In WAN 108, the data can be converted (e.g., encapsulated) in IP, packed into WAN (e.g., SONET or GE) frames, and sent over WAN 108 to switch 112b, where the IP data is reassembled from the WAN frames, and then FC data is again de-encapsulated from the IP frames and sent to router 114b using FC protocol. From router 114b, the data is switched to one of storage elements 132b via switch 110b and adapter 124b. As another example, host 102 can communicate with storage system 104a in a local area network via switches 110d and 110a that use the same protocol, for example, DWDM, thereby alleviating the need to encapsulate the message(s) being transmitted in additional protocol layers.

Adapters 116, 124 that implement dynamic burst mode logic 120, 128 may be implemented in any suitable electronic system, device, or component such as, for example, a host bus adapter, a storage controller, a disk controller, a network management appliance, or others. Adapters 116, 124 may include one or more embedded computer processors that are capable of transferring information at a high rate to support multiple storage elements 132 in a scaleable storage array. Controllers 118, 126 may be connected to the embedded processors and operate as a hub device to transfer data point-to-point or, in some embodiments on a network fabric, among the multiple storage levels. Controllers 118, 126 can have multiple channels for communicating with a cache memory to ensure sufficient bandwidth for data caching and program execution.

Certain devices, such as storage elements 132, may be capable of transferring data at a much higher data rate than other peripheral devices (e.g. storage systems 104, communication devices, printers, etc.). When a number of peripheral devices, and in particular a number of varying types of peripheral devices, are coupled via respective device controllers to the same input/output (I/O) bus (not shown) in host 102, it is undesirable to have one peripheral device monopolize the I/O bus in a data transfer cycle that excludes the other peripheral devices. Device controllers that connect peripheral devices to the I/O bus typically include temporary storage, such as buffer 122, to hold data that is to be transferred from the controlled peripheral device to a processor unit in host 102 in the event the I/O bus is being utilized by another device controller/peripheral device combination. If, however, the other peripheral device takes too long to transfer data, the device controller awaiting access to the I/O bus may experience a data overrun (i.e., the buffer receives more data than it can handle, resulting in the loss of data).

Data overrun problems can be avoided by allowing data transfers to occur in short bursts or blocks of a limited number of data words, after which the peripheral device gives up, and is precluded from, access to the I/O bus until sufficient time has elapsed to permit other peripheral devices access. This ensures that data can be transferred by all of the devices, and avoids any data overrun problems.

The overhead of a data transfer cycle includes the time of preclusion from access to the I/O bus following a data word block transfer—sometimes also referred to as hold-off periods. Data transfers comprising transmission of a number of small data word blocks, each accompanied by a hold-off period that is sometimes larger than the transfer time itself, may result in an effective data transfer rate that is much less than nominal—even when only one peripheral device is involved in the data transfer.

The amount of time required to transfer data between host computer 102 and storage systems 104 can also depend on factors such as the distance between host computer 102 and storage systems 104, the amount of traffic over local networks and WANs 108, and the number of transfers or other tasks contending for space in buffers 122, 130. Hosts 102 and storage systems 104 can be configured to divide a relatively large amount of data into multiple blocks, which can cause significant delay when systems 104 are located far away from host computer 102. For example, a 128 kilobyte write operation from host computer 102 to storage system 104 can take 1 millisecond or more over a distance of 60 miles (100 km) with no network traffic congestion. The same transfer can require 6.3 milliseconds or more to complete when the data is divided into three smaller messages. In contrast, the delay for transfers between systems that are within 1 km of each other is typically negligible. If there is network traffic congestion, or if many tasks are contending for space in buffers 122, 130 or other critical resources to complete the data transfer, the delay due to even a single transfer can be higher than desired. Accordingly, dynamic burst logic 120, 128 can adjust the number/size of messages used to transfer the data depending on factors such as the distance between host computer 102 and local or storage systems 104; the time required to complete data transfers; and/or contention for buffers 122, 130 or other resources required to complete the transfer.

One or more transfer mode parameters can be used to indicate whether the data to be transferred should be sent in one message, or multiple messages. The same or different parameter can also indicate the number of messages to use to transfer the data. One or more components in system 100, such as host 102 and/or storage systems 104, can generate transfer mode parameter(s). In some embodiments, the transfer mode parameters can be communicated among host 102 and storage systems 104 via a separate transfer mode message that is part of a communication protocol, in a field of another message that is part of a communication protocol, or other suitable manner. For example, the transfer mode parameters can be transmitted via one of the open fields that are available for vendor-specified use in the command descriptor block of the SCSI protocol. If host 102 specifies different transfer mode parameter(s) than the target system, then the host and target can negotiate which transfer mode to use based on any suitable criteria, such as a priority level, default selection, and/or operator override, among others.

The transfer mode parameter(s) can be set automatically by dynamic burst logic 120, 128; and/or under external control. For example in some embodiments, a graphical user interface (GUI) 134, 136 may be implemented at host 102 and/or storage systems 104 to enable setting or selection of the transfer mode parameter(s). In some embodiments, when an operator connects a storage element 132 or other component to system 100, he or she can set transfer mode parameters via GUI 136 to indicate the distance between the component and host 104 or other component of system 100, whether to use single or multiple messages to transfer data, the number or size of messages to use, and/or other relevant information. In other embodiments, the operator can set the transfer mode parameter(s) to default values that may be overridden by dynamic burst logic 120, 128. Further, the transfer mode parameter(s) can be initialized/set using other suitable methods such as inputting values from a stored file, or other suitable method. Under automatic control, dynamic burst logic 120, 128 can update the transfer mode parameter(s) for each transfer or periodically. Additionally, when multiple transfers are pending, different transfer mode parameter(s) can be used for each transfer. Further, a read/writable table of transfer mode parameter(s) can be implemented for each host 102, storage system 104, and/or other components in system 100.

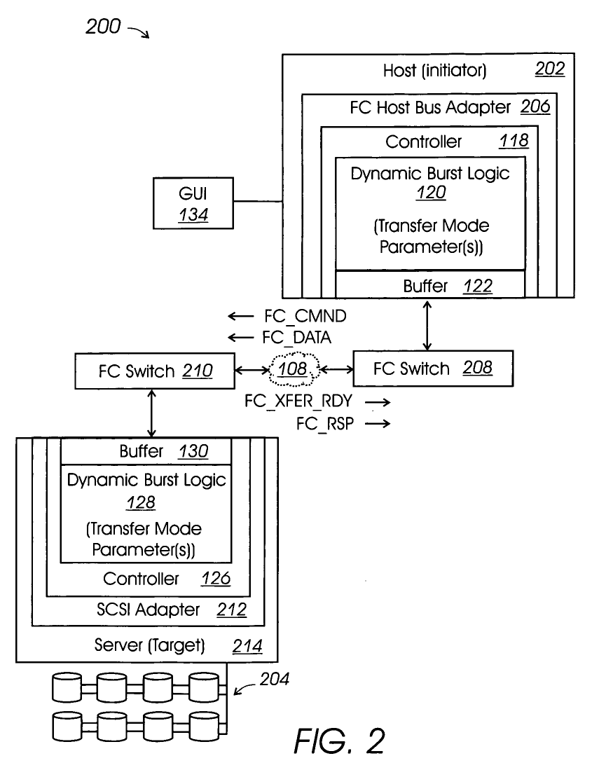

Referring to FIG. 2, an embodiment of Fiber Channel (FC)-SCSI storage area network (SAN) 200 is shown to illustrate the process for host 202 to read data from and write data to SCSI storage elements 204 via FC bus adapter 206, FC switches 208, 210, and SCSI adapter 212 in server (target) computer system 214. Note that the transfer of messages between host 202 and SCSI adapter 212 will be the same whether the messages are transmitted via WAN 108 or not. An object, such as a client application program (not shown), executing in host 202 issues a FC I/O operation by requesting an Execute Command service to FC bus adapter 206. A single request or a list of linked requests may be presented. Each request can include information necessary for the execution of one SCSI command, including the local storage address and characteristics of data to be transferred by the command.

Referring to Table 1 below and FIG. 2, FC bus adapter 206 starts an exchange by sending an unsolicited command information unit (IU) including a FCP_CMND payload, including some command control flags, addressing information, and the SCSI command descriptor block (CDB). FC bus adapter 206 includes an Execute Command service that uses the FCP_CMND payload to start a FC I/O operation.

SCSI adapter 212 interprets the command to determine whether data is to be received or sent. Once the send or receive operation is ready to be performed, SCSI adapter 212 sends a data descriptor IU including the FCP_XFER_RDY payload to host 202 (the initiator) to indicate which portion of the data is to be transferred.

If the SCSI command described a write operation, host 202 transmits a solicited data IU to server 214 (the target) including the FCP_DATA payload requested by the FCP_XFER_RDY payload. Table 1 shows examples of three separate message sequences for writing data to storage elements 204 100 km from host 202 using multiple messages, including the (delta) time required to complete the sequences measured from a host port in bus adapter 206.

If the SCSI command describes a read operation, server 214 transmits a solicited data IU to host 202 including the FCP_DATA payload described in the FCP_XFER_RDY payload. Data delivery requests including FCP_XFER_RDY and FCP_DATA payloads are transmitted until all data described by the SCSI command is transferred. Exactly one FCP_DATA IU follows each FCP_XFER_RDY IU.

After all the data has been transferred, server 214 transmits an Execute Command service response by requesting the transmission of an IU including a FCP_RSP payload. The FCP_RSP payload includes SCSI status information and, if an unusual condition has been detected, SCSI REQUEST SENSE information and the FC response information describing the condition. The command status IU terminates the command. Server 214 determines whether additional commands will be performed in the FC I/O operation. If this is the last or only command executed in the FC I/O operation, the FC I/O operation and the exchange are terminated.

When the command is completed, returned information is used to prepare and return the Execute Command service confirmation information to the client application software that requested the operation. The returned status indicates whether or not the command was successful. The successful completion of the command indicates that the SCSI storage element 204 performed the desired operations with the transferred data and that the information was successfully transferred to or from host 202.

If the command is linked to another command, the FCP_RSP payload contains the proper status indicating that another command will be executed. The target presents the FCP_RSP in an IU that allows command linking. The initiator continues the same exchange with an FCP_CMND IU, beginning the next SCSI command.

TABLE 1
FC-SCSI Write Exchange (three separate transfers)

| Se- | | | Data | | |
|---|---|---|---|---|---|
| quence | Operation | Information Unit | Size | Delta Time | |
| 1 | FCP_Request | FCP_CMND | | 1.039 | ms |
| | Init −> Tgt | | | | |
| 2 | FCP_Request | FCP_XFER_READY | | 16.172 | us |
| | Tgt −> Init | | | | |
| 3 | FCP_Response | FCP_DATA | 512 | 1.028 | ms |
| | Init −> Tgt | | Bytes | | |
| 4 | FCP_Request | FCP_XFER_READY | | 26.593 | us |
| | Tgt −> Init | | | | |
| 5 | FCP_Response | FCP_DATA | 49152 | 1.42 | ms |
| | Init −> Tgt | | Bytes | | |
| 6 | FCP_Request | FCP_XFER_READY | | 26.368 | us |
| | Tgt −> Init | | | | |
| 7 | FCP_Response | FCP_DATA | 49152 | 1.418 | ms |
| | Init −> Tgt | | Bytes | | |
| 8 | FCP_Request | FCP_XFER_READY | | 26.933 | us |
| | Tgt −> Init | | | | |
| 9 | FCP_Response | FCP_DATA | 32256 | 1.283 | ms |
| | Init −> Tgt | | Bytes | | |
| 10 | FCP_Response | FCP_RSP | | | |
| | Tgt −> Init | | | | |

By comparison, Table 2 shows an example of the timing of a single burst transfer for the same amount of data over a similar distance. The overall delta time required to transfer the data in three separate sequences (shown by sequences 5, 7, and 9) in Table 1 is approximately 4.12 ms (1.42 ms+1.418 ms+1.283 ms), while requiring only 2.1 ms for a single sequence (shown by sequence 3) in Table 2. Note, however, that 2.1 ms is approximately 50-75% greater than the amount of time required for each sequence that transfers only a portion of the data. In some situations, it is preferable to incur the additional overhead of transferring data over multiple sequences rather than imposing a significantly longer hold-off period on other operations vying for bus time.

TABLE 2
FC-SCSI Write Exchange (single transfer)

| Se- | | | Data | | |
|---|---|---|---|---|---|
| quence | Operation | Information Unit | Size | Delta Time | |
| 1 | FCP_Request | FCP_CMND | | 1.039 | ms |
| | Init −> Tgt | | | | |
| 2 | FCP_Request | FCP_XFER_READY | | 16.172 | us |
| | Tgt −> Init | | | | |
| 3 | FCP_Response | FCP_DATA | 131072 | 2.1 | ms |
| | Init −> Tgt | | Bytes | | |
| 4 | FCP_Response | FCP_RSP | | | |
| | Tgt −> Init | | | | |

The number of FC I/O operations that may be active at one time depends on the queuing capabilities of the particular SCSI storage elements 204 and the number of concurrent exchanges supported by switches 208, 210. Note that although FIG. 2, Table 1, and Table 2 show examples of data transfers using FC-SCSI protocols, embodiments disclosed herein are not intended to be limited to a particular protocol or combination of protocols.

The transfer mode parameter(s) can be determined in host 202 and/or target server 214. Additional logic can be included to determine which transfer mode parameter(s) to use if the transfer mode parameter(s) determined by host 202 and server 214 are different.

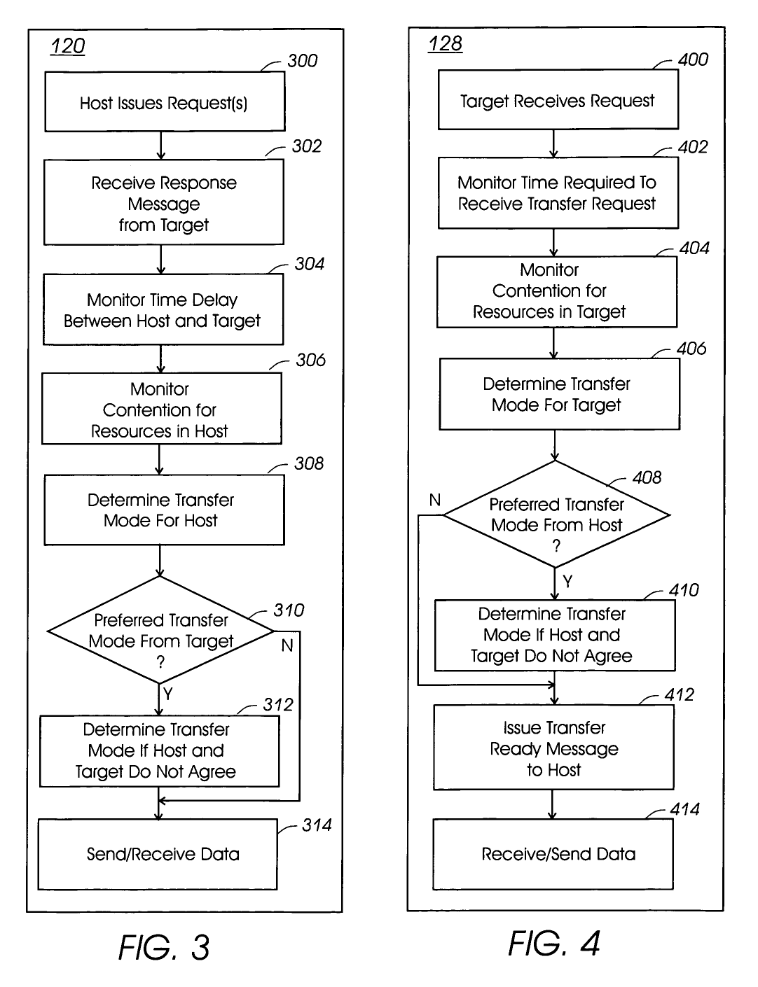

Referring to FIGS. 1 and 3, FIG. 3 shows a flow diagram of an embodiment of a method that can be implemented in dynamic burst logic 120 or other suitable modules(s) to determine transfer mode parameter(s), which can dynamically adjust the number or size of messages for data transfers to and from host 102. In process 300, the host issues a message that includes a command/request to send data to, or receive data from, a target system, such as one of storage systems 104. Process 302 receives the response message from the target system. The response message can include information such as whether the target is ready to fulfill the request, the transfer mode parameter(s), and other information that is relevant to the host regarding the transfer.

Process 304 can include monitoring the time delay between the host and the target system. For example, in some embodiments, when data is transferred in a single sequence from the host to a target using FC-SCSI protocols, process 304 can measure the time between sending of simple SCSI commands such as SCSI TEST UNIT READY and the receipt of command completion

Process 306 can include monitoring contention for various resources in the host that are involved with data transfers, and/or other operations with systems external to the host that may be split into multiple steps. For example, buffer 122 in bus adapter 116 may be used by several client application programs in host 102. Buffer 122 may not be large enough to fit all of the data to be transferred in one burst for all tasks requesting data transfers. If the amount of time the applications would have to wait to use the required amount of buffer 122 for a time period that is greater than the time delay associated with making multiple transfers, then process 308 can set the host transfer mode parameter(s) to indicate that multiple messages will be used. Process 308 can also determine the number or size of messages to use based on the level of contention for buffer 122 compared to the delay associated with transferring the data in more than one message. Note that process 306 can also monitor contention for other resources, such as other buffers, an input/output bus, or the availability of switch 110d, relevant to the operation(s) to be performed.

Process 308 can compare the time delay for multiple transfers to the delay associated with transferring the data in one single burst. When the delay associated with multiple transfers is larger than the delay for a single transfer for approximately the same amount of data, then subsequent transfers can be made using a single burst transfer. Otherwise, the data can be divided into multiple transfers.

The transfer mode parameter(s) can be set in process 308 to indicate whether single or multiple bursts are to be used, and/or the number/size of transfers. One or more transfer mode priority parameter(s) indicating how strictly the host should adhere to the preferred number/size of transfers can also be set based on one or more suitable factors, such as the magnitude of the time delay, the level of contention for resources in the host, and the variance in the factors, for example. The priority parameter(s) can also be used to indicate whether the transfer mode is negotiable in the event the host and the target prefer different transfer modes, and the extent to which the priority can be compromised. The values associated with the transfer mode priority parameter can be standardized across hosts and targets to allow meaningful comparison in the event the host prefers one transfer mode and the target prefers another.

Process 310 can include determining whether the target has indicated a preferred transfer mode to the host. If not, then the operation, such as sending or receiving data, can be performed in process 314. If so, then process 312 can include determining whether the transfer modes for the host or the target are negotiable, and if so, whether the transfer mode preferred by the host or target should be used. In some embodiments, the priority parameters for the host and the target can be compared, and the higher priority overrides the lower priority. In other embodiments, the number of transfers to be used can be adjusted to compromise between single burst mode or multiple burst mode. For example, instead of using 1 or 4 transfers, the number of transfers can be adjusted to 2 or 3, depending on the extent to which the priority can be adjusted as indicated by the priority parameter(s). Other suitable compromises or techniques for determining an appropriate transfer mode between the host and target can be used. If a new transfer mode has been determined in process 312, the transfer mode can be communicated to the target before the data is sent or received in process 314.

Referring now to FIGS. 1 and 4, FIG. 4 shows a flow diagram of an embodiment of a method that can be implemented in dynamic burst logic 128 or other suitable modules(s) to determine transfer mode parameter(s), which can dynamically adjust the number of messages for data transfers to and from the target, such as storage system 104. In process 400, the target receives a message that includes a command/request to send data to, or receive data from, a host system 102.

Process 402 can include monitoring the time delay between the target and the host system. For example, in some embodiments, when data is transferred in a single message from the target to a host using FC-SCSI protocols, process 402 can measure the time between sending the FCP_XFER_RDY response and the arrival of FCP_DATA, which represents the time required to complete a roundtrip between the host and SCSI storage elements.

Process 404 can include monitoring contention for various resources in the target that are involved with data transfers, and/or other operations with systems external to the target that may be split into multiple steps. For example, buffer 130 in adapter 124b may be used by several components in storage system 104. Buffer 130 may not be large enough to fit all of the data to be transferred in one burst for all tasks requesting data transfers. If the amount of time the operations would have to wait to use the required amount of buffer 130 that is greater than the time delay associated with making multiple transfers, then process 406 can set the host transfer mode parameter(s) to indicate that multiple messages will be used. Process 406 can also determine the number of messages to use based on the level of contention for buffer 130 compared to the delay associated with transferring the data in more than one message. Note that process 404 can also monitor contention for other resources, such as an input/output bus or the availability of switch 110b, relevant to the operation(s) to be performed.

Process 406 can compare the time delay for multiple transfers to the delay associated with transferring the data in one single burst. When the delay associated with multiple transfers is larger than the delay for a single transfer for approximately the same amount of data, then subsequent transfers can be made using a single burst transfer. Otherwise, the data can be divided into multiple transfers.

The transfer mode parameter(s) can be set in process 406 to indicate whether single or multiple bursts are to be used, and/or the number of transfers. One or more transfer mode priority parameter(s) indicating how strictly the target should adhere to the preferred number of transfers can also be set based on one or more suitable factors, such as the magnitude of the time delay, the contention for resources in the target, and the variance in the factors, for example. The priority parameter(s) can also be used to indicate whether the transfer mode is negotiable in the event the target and the host prefer different transfer modes, and the extent to which the priority can be compromised. The values associated with the transfer mode priority parameter can be standardized across hosts and targets to allow meaningful comparison in the event the target prefers one transfer mode and the host prefers another.

Process 408 can include determining whether the host has indicated a preferred transfer mode to the target. If not, process 412 can send a message to the host to indicate that it is ready to send or receive the data. If so, then process 410 can include determining whether the transfer modes for the host or the target are negotiable, and if so, whether the transfer mode preferred by the host or target should be used. In some embodiments, the priority parameters for the host and the target can be compared, and the higher priority overrides the lower priority. In other embodiments, the number of transfers to be used can be adjusted to compromise between single burst mode or multiple burst mode. For example, instead of using 1 or 4 transfers, the number of transfers can be adjusted to 2 or 3, depending on the extent to which the priority can be adjusted as indicated by the priority parameter(s). Other suitable compromises or techniques for determining an appropriate transfer mode between the host and target can be used. If a new transfer mode has been determined in process 410, new transfer mode parameter(s) can be communicated to the host before the data is sent or received in process 414.

Process 412 sends a response message to the host system. The response message can include information such as whether the target is ready to fulfill the request, the transfer mode parameter(s), and other information that is relevant to the host regarding the transfer. The operation, such as sending or receiving data, can be performed in process 414.

Note that processes 300-314 and/or 400-414 are performed can be performed periodically. The frequency at which processes 300-314 and 400-414 are performed can be based on the overhead associated with performing the processes and/or to the expected variance in time delays for single and multiple transfers.

The logic instructions, processing systems, and circuitry described herein may be implemented using any suitable combination of hardware, software, and/or firmware logic instructions, such as general purpose computer systems, workstations, servers, Field Programmable Gate Arrays (FPGAs), Application Specific Integrated Circuit (ASICs), magnetic storage media, optical storage media, and other suitable computer-related devices. The logic instructions can be independently implemented or included in one of the other system components. Similarly, other components are disclosed herein as separate and discrete components. These components may, however, be combined to form larger or different software modules, logic modules, integrated circuits, or electrical assemblies, if desired.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, the disclosed apparatus and technique can be used in any storage and communication configuration with any appropriate number of storage arrays or elements. The various adapters and communication controllers may be implemented in any suitable component or device, for example host computers, host bus adapters, storage controllers, disk controllers, management appliances, and the like. Although, the illustrative system discloses magnetic disk storage elements, any appropriate type of storage technology may be used.

In the claims, unless otherwise indicated the article “a” is to refer to “one or more than one”.

I claim:

1. A computer product comprising:
a communication controller operable to:
issue a first request to a target system;
receive a response message from the target system;
monitor time delay associated with communicating with the target system;
monitor contention for resources in a host computer system; and
determine a host transfer mode for the host computer system based on the time delay and the contention for resources in the host computer system, wherein the host transfer mode indicates whether data should be transferred in one message or multiple messages to and from the host computer system.

2. The computer product of claim 1 wherein the communication controller is further operable to:
determine whether the target system has indicated a target transfer mode to the host computer system; and
determine a compromise transfer mode representing the host transfer mode, the target transfer mode, or a combination of the host and target transfer modes based on a host transfer mode priority parameter and a target transfer mode priority parameter.

3. The computer product of claim 1 wherein the communication controller is further operable to:
communicate with the target system using Fiber Channel (FC) and Small Computer Systems Interface (SCSI) communication protocols.

4. The computer product of claim 3 wherein the time delay associated with communicating with the target system represents the time required to receive the response message from the target system.

5. The computer product of claim 1 wherein the communication controller is further operable to:
communicate the host transfer mode to the target system.

6. The computer product of claim 1 wherein the frequency that the host transfer mode is determined is based on the overhead associated with determining the host transfer mode and the expected variance in time delays for single and multiple transfers.

7. The computer product of claim 2 wherein the communication controller is further operable to:
communicate the compromise transfer mode to the target system.

8. The computer product of claim 1 further comprising:
a graphical user interface (GUI) operable to allow a user to set the host transfer mode.

9. The computer product of claim 1 further comprising:
a processing device coupled to the communication controller.

10. A computer-implemented method for performing dynamic burst transfers between a first computer system and a second computer system, comprising:
monitoring time delay associated with communicating messages between the first computer system and the second computer system;
monitoring contention for resources in at least one of the first computer system and the second computer system; and
determining a transfer mode based on the time delay and the level of contention for resources, wherein the transfer mode indicates whether data should be transferred in one message or multiple messages between the first and second computer systems.

11. The computer-implemented method of claim 10 further comprising:
determining a transfer mode priority parameter, wherein the priority parameter indicates how strictly the first computer should adhere to the transfer mode based on at least one of the group consisting of: the magnitude of the time delay, the level of contention for resources in the first computer, variance in the time delay, and variance in the level of contention.

12. The computer-implemented method of claim 10 further comprising:
using at least one of the group consisting of: Fiber Channel (FC) and Small Computer Systems Interface (SCSI) communication protocols, in the first computer system and the second computer system.

13. The computer-implemented method of claim 12 wherein the time delay associated with communicating between the first and second computer systems is based on the time between receiving a FC_XFER_RDY request and a FC_RSP response in the first computer system.

14. The computer-implemented method of claim 10 further comprising:
determining whether the second computer system has indicated a transfer mode to the first computer system.

15. The computer-implemented method of claim 10 wherein the transfer mode is determined periodically based on the overhead associated with determining the host transfer mode, the expected variance in time delays for single and multiple transfers, and the level of contention for resources.

16. The computer-implemented method of claim 10 further comprising:
determining a transfer mode for the first computer system and the second computer system;
if the transfer mode for the first computer system is not the same as the transfer mode for the second computer system, determining in the first computer system a compromise transfer mode representing the transfer mode for the first computer system, the transfer mode for the second computer system, or a combination of the transfer mode for the first computer system and the transfer mode for the second computer system; and
communicating the compromise transfer mode to the second computer system.

17. An apparatus comprising:
means for determining a first amount of time required to transfer data between two computer systems in single transfer mode using one transfer;
means for determining a second amount of time required to transfer data between the computer systems in multiple transfer mode using multiple transfers;
means for comparing the first amount of time to the second amount of time; and
means for determining a preferred transfer mode based on the first amount of time and the second amount of time.

18. The apparatus of claim 17, further comprising:
means for communicating a remote transfer mode from one of the two computer systems to the other of the two computer systems;
means for comparing the remote transfer mode to the preferred transfer mode; and
means for determining whether to use the remote transfer mode or the preferred transfer mode.

19. The apparatus of claim 18, further comprising:
means for determining priority of the remote transfer mode;
means for determining priority of the preferred transfer mode; and
means for combining the remote transfer mode and the preferred transfer mode.

20. The apparatus of claim 17, further comprising:
means for allowing a user to indicate the preferred transfer mode when a device is installed in one of the two computer systems.
